(19) United States
(12) Patent Application Publication
(10) Pub. No.: US 2026/0130341 A1
(43) Pub. Date: May 14, 2026

(54) ANIMAL HUSBANDRY SYSTEM

(71) Applicant: LELY PATENT N.V., Maassluis (NL)

(72) Inventors: Paulus Jacobus Maria VAN ADRICHEM, Maassluis (NL); Korstiaan Cornelis BLOKLAND, Maassluis (NL); Adrianus Cornelis Maria (Adrie) MEEUWESEN, Maassluis (NL); Paul Guy VAN HOUTUM, Maassluis (NL)

(73) Assignee: LELY PATENT N.V., Maassluis (NL)

(21) Appl. No.: 19/118,027

(22) PCT Filed: Oct. 13, 2023
(86) PCT No.: PCT/IB2023/060334

§ 371 Date: Apr. 3, 2025

(30) Foreign Application Priority Data
Oct. 21, 2022 (NL) 2033368
Sep. 12, 2023 (NL) 2035786

(51) Int. Cl. A01K 11/00; A01J 5/00; A01K 29/00

(52) U.S. Cl. CPC A01K 11/006; A01J 5/00; A01K 29/005

(57) ABSTRACT

The present invention relates to an animal husbandry system, wherein a group of animals can move about freely in an area, the system comprising identification means configured for determining the identity of each individual animal, tracking means configured for tracking the position of each individual animal, and attention means configured for identifying an attention animal having a predetermined condition, wherein the system is configured for automatically determining a subgroup of animals that have been in a predetermined relationship with the attention animal. The determination of such a subgroup is highly useful. For example, it can be established whether the animals in the subgroup also have the predetermined condition of the attention animal. This is helpful in order to be able to contain the spreading of the predetermined condition, if this is desired.

The present invention relates to an animal husbandry system, wherein a group of animals can move about freely in an area, the system comprising identification means configured for determining the identity of each individual animal, tracking means configured for tracking the position of each individual animal, and attention means configured for identifying an attention animal having a predetermined condition.

Such systems are known in the art. Monitoring the animals in the system and gathering relevant animal data plays an important role in such systems. Being able to identify animals with a certain condition is very useful.

WO2018/174812 describes a video monitoring system for identifying an individual animal in a group of animals in an area each carrying an identification tag. An event of interest related to the individual animal is detected, after which the animal in question is tracked and its identity is determined by means of the identification tag as soon as it visits an identification station. Multiple animals may be tracked at the same time, when multiple events of interest have been detected. Not all individual animals are constantly tracked. WO2012/078054 is concerned with an apparatus for monitoring a milking animal during milking using thermographic cameras to detect certain conditions. EP3335551 discloses a method of monitoring livestock inside of a building using a camera arranged above the livestock for gathering tracking data relating to a motion of a tracked individual animal. The motion data thus obtained can be compared to stored motion data or motion patterns related to or associated with a special state or condition of an animal.

There is a need for an improved and more versatile system.

It is an object of the present invention to provide such an improved system.

The invention achieves the object at least in part by means of a system according to claim 1, in particular an animal husbandry system, wherein a group of animals can move about freely in an area, the system comprising identification means configured for determining the identity of each individual animal, tracking means configured for tracking the position of each individual animal, and attention means configured for identifying an attention animal having a predetermined condition, wherein the system is configured for automatically determining a subgroup of animals that have been in a predetermined relationship with the attention animal.

The determination of such a subgroup is highly useful. For example, it can be established whether the animals in the subgroup also have the predetermined condition of the attention animal. This is helpful in order to be able to contain the spreading of the predetermined condition, if this is desired. Thus, a user-friendly, animal-friendly and safe animal husbandry system is realized.

The invention is based on the insight that the use of identification and tracking means enables an automatic and accurate determination of all the animals that have been in some form of contact with an attention animal. This can be achieved in a very animal-friendly way, without the use of additional equipment. The early detection of a contact of an animal to an attention animal having a certain condition can help prevent serious health complications for the animal in question.

Suitable and advantageous embodiments are described in the dependent claims, as well as in the description below.

According to a first embodiment of the invention, the tracking means comprise at least one camera, a processor or a computer processing unit, and image analysis means. This constitutes a very accurate and animal-friendly implementation.

According to a further embodiment, the attention means comprise attention analysis means in a milking robot. The milking robot inherently contains a lot of measuring equipment and is thus highly suitable for generating an attention. Moreover, this can be done automatically.

Advantageously, the identification means comprise tags wearable by each animal and a tag reader. This is a very simple, yet effective implementation.

In a further embodiment, the identification means comprise image analysis means. In this way, an excellent animal identification accuracy is obtained.

In yet another embodiment, the predetermined condition is a disease or an injury. Monitoring animals that have been in some form of contact with sick or injured animals is very important in order to be able to avoid spreading of the disease or the occurrence of unnoticed injuries. For example, animals having been in close contact with a sick animal can be separated or isolated. Animals having visited the same locations in a stable which an injured animal has visited can be checked for injuries.

Advantageously, the predetermined condition is estrus or heat. Thus, animals in heat can be properly dealt with. For example, they can be separated for artificial insemination.

According to a further embodiment, the predetermined relationship with the attention animal is a distance below a threshold value. In this way, a close contact between the animals is ascertained.

In yet another embodiment, the predetermined relationship with the attention animal is a distance below a threshold value during at least a minimum time interval. Brief encounters can thus be excluded. This has proven to give excellent results.

Advantageously, the predetermined relationship with the attention animal is the use of the same cubicle. In this way, it is also possible to ascertain an indirect body contact between animals. In a cubicle used by a sick animal, contamination of a next animal visiting the cubicle can take place.

In accordance with a further embodiment, the predetermined relationship with the attention animal is the use of the same fodder or water trough. Thus, also indirect oral contact between animals can be ascertained. Furthermore, comparing animals who have eaten from the same batch of food enables a very accurate feed efficiency analysis, because variations caused by different food batch qualities can be eliminated.

In yet another embodiment, the predetermined relationship with the attention animal is mounting the attention animal or being mounted by the attention animal. This is an indication of heat, enabling a proper handling of the animals in question.

Highly advantageously, the attention means are configured for automatically identifying animals in the determined subgroup as attention animals. In this way, animals in the subgroup also having the predetermined condition of the attention animal are automatically identified. This is helpful in order to be able to contain the spreading of the predetermined condition. As this is done automatically, for example in a milking robot, it is also very user-friendly.

In a preferred embodiment, means are provided configured for automatically taking appropriate action in dependence on the determined subgroup of animals and in function of the predetermined condition and the predetermined relationship. In this way, animal health and welfare can be efficiently protected. Again, the automation makes it very user-friendly. For example, animals having been in some form of contact with a sick animal or an animal in heat can be automatically separated in order to be checked and/or treated. A cubicle or a milking robot occupied by an animal having been in contact with a sick animal can be automatically cleaned. Appropriate actions in different occurring cases can be readily implemented.

In yet a further embodiment, the system further comprises a treatment area and a selection gate for guiding an animal to the treatment area, the attention means being arranged to automatically activate the selection gate in order to guide animals in the determined subgroup of animals to the treatment area. This is highly useful and user-friendly for the farmer. Moreover, animal health and welfare can be improved.

Advantageously, the image analysis means are configured for determining the body orientation of each individual animal. This is helpful in making the system even more reliable.

The invention will now be further explained with reference to the following Figure, which schematically illustrates the system according to the invention.

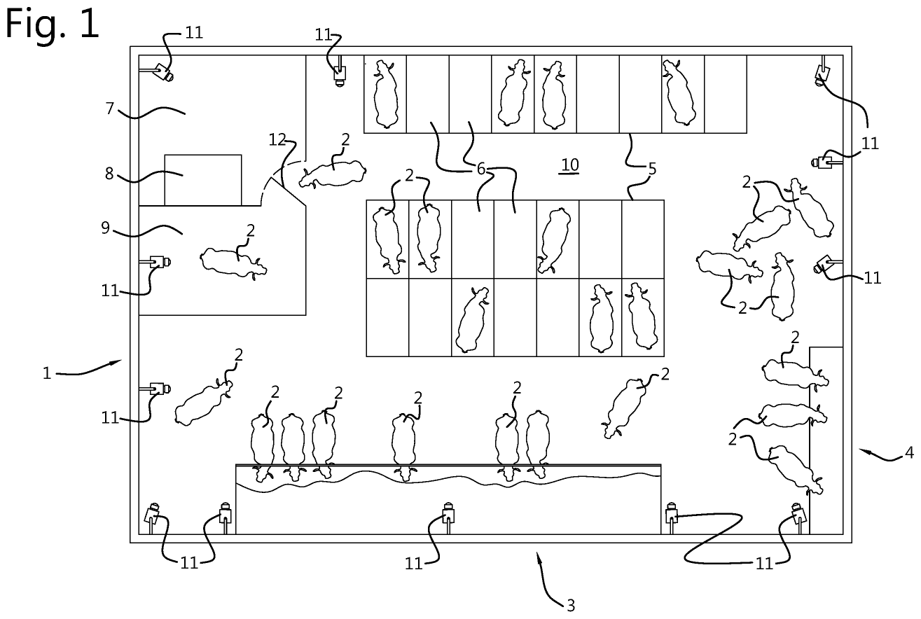

FIG. 1 shows an area with an animal husbandry system according to the invention.

In FIG. 1 an animal husbandry system with an area here in the form of a stable or shed or barn 1 wherein a group of animals 2 can move about freely is shown. In the example shown the animals are cows. Of course, the invention can also be applied to an animal husbandry system involving other animals, such as goats, pigs, horses, or even chickens, turkeys, etcetera. The stable 1 can also be a structure with, for example, a partly open roof. The system according to the invention can be applied in a free stall barn or in an open area like a meadow or pasture with cattle fences.

In the example shown, the stable 1 has a number of activity areas for the animals 2: a feeding area 3, a drinking area 4, at least one resting area 5 with cubicles 6, a milking area 7 with a milking robot 8, and a treatment area 9. All these areas are interconnected by an alley 10.

Monitoring and analyzing means configured for determining and tracking the identity and the position of each individual animal 2 are provided, in the embodiment shown in the form of a number of cameras 11 and a processor with appropriate software, as will be elucidated below.

The cameras 11 are arranged for monitoring a region or a subarea or a number of subareas of the stable 1. Of course, other (optical) sensors can in principle be used instead of the cameras 11, or additionally. The cameras 11 are provided in such a way that, collectively, they are configured for monitoring substantially the complete shed 1, particularly all the animals 2. The cameras 11 can be provided in the shed 1 above the animals 2 (e.g. centrally, optionally only one camera can be used), or as shown in FIG. 1, on the walls of the shed 1.

The cameras 11 can be fixedly positioned and oriented in such a way that all relevant subareas of the area 1 can be monitored. Alternatively, they may be mounted in a pivotable way. The subareas may overlap. In case the invention is used in a pasture, the cameras 11 may be provided on fences, at a sufficient height above the ground. The chosen configuration obviously depends on the shape of the area or shed 1.

Suitable illumination means (not shown) for the shed 1 are also provided.

In an alternative embodiment, separate identification means are provided configured for determining the identity of each individual animal 2. These separate identification means can be in the form of a tag wearable by each animal 2, which tag can be read by at least one tag reader, provided e.g. in the milking robot 8, at the feeding area 3, at the drinking area 4, or on a vehicle which is moveable in the area 1, e.g. a cleaning vehicle (not shown). In that case, the tags may also be read by means of the cameras 11.

The cameras 11 are connected to a processor or a computer processing unit, and image analysis means (known as such, not shown). With the aid of the cameras 11, the processor and the image analysis means the animals 2 can be continuously tracked in the shed 1. Preferably, the identification means are also formed by the cameras 11, the processor and the image analysis means, so that it is not necessary for the animals 2 to wear tags. Thus, the cameras 11, the processor and the image analysis means form identification means configured for determining the identity of each individual animal 2 and tracking means configured for tracking the position of each individual animal 2.

Furthermore, attention means configured for identifying an attention animal having a predetermined condition are provided. The farmer can provide input for the attention means, but preferably the means are automated. To this end, the milking robot 8 is provided with attention analysis means. The milking robot 8 inherently contains a lot of measuring equipment and is thus configured for generating an attention automatically.

For example, the milk quality is analysed in the milking robot 8 and the attention analysis means recognize a certain predetermined disease, e.g. with the aid of stored historical data. Also, animal body parts (like the udder of a cow) can be recorded in the milking robot 8. Image analysis can then establish whether the animal in question has a predetermined condition by comparing the recorded image with stored reference data.

In accordance with the invention, the system is configured for automatically determining a subgroup of animals 2 that have been in a predetermined relationship with the attention animal. The predetermined relationship can be any kind of contact, e.g. an encounter at a distance below a given threshold value, the use of a same cubicle 6 or trough, or the visit of a same location in the area 1. This can be used for establishing whether the animals 2 in the subgroup also have the predetermined condition of the attention animal. This is helpful in order to be able to contain the spreading of the predetermined condition, e.g. a disease.

The use of identification and tracking means enables an automatic and accurate determination of all the animals 2 that have been in some form of contact with an attention animal. This can be achieved in a very animal-friendly way, without the use of additional equipment. The early detection of a contact of an animal to an attention animal having a certain condition can help prevent serious health complications for the animal in question.

The predetermined condition can be a disease or an injury. For example, Mortellaro's disease or Italian foot rot, which is a claw disease, can be diagnosed in the milking robot 8 by means of (video) image analysis. IBR or cow flu is a highly contagious and infectious viral disease that affects cattle of all ages. It can be detected by means of analysis of the milk. Animals having been in contact with an infected animal 2 can be identified in accordance with the invention. Then, further action can be taken, as explained below.

If an animal 2 has been at a distance below a threshold value (e.g. 1 meter) of the attention animal, it is at risk of having caught the attention animal's disease. Close contact between the animals can be ascertained with the identification and tracking means. A suitable threshold value may be found by trial and error. The distance between the animals 2 can e.g. be measured between their heads.

As a further refinement, it is also possible to establish whether an animal 2 has been at a distance of the attention animal below a threshold value during at least a minimum time interval, so that brief encounters can be excluded.

Particularly, when a number of cows 2 has been in close contact for some time, that is within a certain distance from one another during at least a minimum time interval, this is a strong indication of estrus or heat.

For example, two cows in each other's vicinity are assigned a heat score when they stay within a certain maximum distance from one another, and this heat score is increased if they stay or move together. As soon as the heat score reaches a certain threshold, it is concluded that the cows are in heat.

It can also be established whether an animal 2 has used the same cubicle 6 as the attention animal. In this way, it is also possible to ascertain an indirect body contact between animals. In a cubicle 6 used by a sick animal, contamination of a next animal 2 visiting the cubicle may have taken place.

Also, the use of the same fodder or water trough can be established. Thus, also indirect oral contact between animals can be ascertained, by means of which a contamination could have taken place. Then, animals 2 having been at risk can e.g. be separated or isolated.

Comparing animals who have eaten from the same batch of food enables a very accurate feed efficiency analysis, because variations caused by different food batch qualities can be eliminated. In accordance with the invention, a subgroup of animals 2 that have eaten from the same batch of food can readily be determined.

In case of injuries it is very useful to be able to establish which animals 2 have visited the same location(s) as the wounded animal. For example, when an animal 2 has hardware disease (a cow has ingested a sharp, metallic object), it is useful to know at which water trough or fodder trough the animal 2 has eaten and which other animals 2 have done the same recently. Generally, animals 2 having visited the same locations in a stable which an injured animal has visited should be checked for injuries.

The predetermined condition can also be estrus or heat. An animal mounting the attention animal or being mounted by the attention animal is probably in heat. Animals in heat should be properly dealt with. For example, they can be separated for artificial insemination.

The attention means are configured for automatically identifying animals 2 in the determined subgroup as attention animals. Thus, animals 2 in the subgroup also having the predetermined condition of the attention animal are automatically checked and identified. This is helpful in order to be able to contain the spreading of the predetermined condition. As this is done automatically, for example in the milking robot 8, it is very user-friendly.

In a preferred embodiment, means are provided configured for automatically taking appropriate action in dependence on the determined subgroup of animals 2 and in function of the predetermined condition and the predetermined relationship. Thus, animal health and welfare can be efficiently protected. The automation makes it very user-friendly. For example, animals 2 having been in some form of contact with a sick animal or an animal in heat are automatically separated in order to be checked and/or (medically) treated. A cubicle 6 and/or a milking robot 8 and/or a milking box and/or a fodder trough and/or a water trough occupied or visited by an animal 2 having been in contact with a sick animal is automatically cleaned. Also, locations visted by a sick animal 2 may be automatically cleaned and/or disinfected. Appropriate actions in different occurring cases can be readily implemented.

The system further comprises (optionally) a treatment area 9 and a selection gate 12 for guiding an animal 2 to the treatment area 9, the attention means being arranged to automatically activate the selection gate 12 in order to guide animals in the determined subgroup of animals 2 to the treatment area 9. This is useful and user-friendly for the farmer, as it is automated. Animal health and welfare is improved. For example, an animal 2 leaving the milking robot 8 in the milking area 7 can be guided directly into the treatment area 9, as soon as it has been determined that it is an attention animal.

Advantageously, the image analysis means are configured for determining the body orientation of each individual animal. This is helpful in making the system even more reliable, as it aids in tracking the animal's movements more precisely.

In order to enhance the animal identification and tracking accuracy of the system, additional identification means may be provided for identifying individual animals 2 in the area 1. This can be done in various ways, known as such. For example, Radio Frequency Identification with tags/transponders and an antenna with a reader can be used. Alternatively, image analysis can be used with the aid of the cameras 11, e.g. recognizing the spotted pattern on the back of cows 2. Images of all cameras 11 can be combined to track each cow 2 in the whole barn 1. A further possibility involves resetting the position of an animal 2 every time it visits a certain known location, for example when a cow 2 visits the milking robot 8 in the milking area 7, and then tracking the animal 2 from that known location using the monitoring means 11. Knowing the exact location of the animals 2 in the area 1 has a lot of advantages: individual animal data can be gathered.

Thus, a very efficient, yet animal-friendly system is realized. The use of monitoring and analyzing means (cameras 11 with processor and image analysis means) enables an automated tracing of animals 2 moving about freely in the area 1 which have been in some form of contact with an attention animal. Then, appropriate action is taken.

1. An animal husbandry system, wherein a group of animals can move about freely in an area, the system comprising:
identification means configured for determining an identity of each individual animal,
tracking means configured for tracking position of each individual animal, and
attention means configured for identifying an attention animal having a predetermined condition,
wherein the system is configured for automatically determining a subgroup of animals that have been in a predetermined relationship with the attention animal.

2. The system according to claim 1, wherein the tracking means comprise at least one camera, a processor or a computer processing unit, and image analysis means.

3. The system according to claim 1, wherein the attention means comprise attention analysis means in a milking robot.

4. The system according to claim 1, wherein the identification means comprise tags wearable by each animal and a tag reader.

5. The system according to claim 1, wherein the identification means comprise image analysis means.

6. The system according to claim 1, wherein the predetermined condition is a disease or an injury.

7. The system according to claim 1, wherein the predetermined condition is estrus or heat.

8. The system according to claim 1, wherein the predetermined relationship with the attention animal is a distance below a threshold value.

9. The system according to claim 1, wherein the predetermined relationship with the attention animal is a distance below a threshold value during at least a minimum time interval.

10. The system according to claim 1, wherein the predetermined relationship with the attention animal is the use of the same cubicle.

11. The system according to claim 1, wherein the predetermined relationship with the attention animal is the use of the same fodder or water trough.

12. The system according to claim 1, wherein the predetermined relationship with the attention animal is mounting the attention animal or being mounted by the attention animal.

13. The system according to claim 1, wherein the attention means are configured for automatically identifying animals in the determined subgroup as attention animals.

14. The system according to claim 1, further comprising:
means for automatically taking appropriate action in dependence on the determined subgroup of animals and in function of the predetermined condition and the predetermined relationship.

15. The system according to claim 1, further comprising:
a treatment area and a selection gate for guiding an animal to the treatment area,
wherein the attention means is arranged to automatically activate the selection gate in order to guide animals in the determined subgroup of animals to the treatment area.

16. The system according to claim 2, wherein the image analysis means are configured for determining the body orientation of each individual animal.

17. The system according to claim 2, wherein the attention means comprise attention analysis means in a milking robot.

18. The system according to claim 2, wherein the identification means comprise tags wearable by each animal and a tag reader.

19. The system according to claim 3, wherein the identification means comprise tags wearable by each animal and a tag reader.

20. The system according to claim 2, wherein the identification means comprise image analysis means.
